(19) United States
(12) Patent Application Publication
(10) Pub. No.: US 2015/0283796 A1
(43) Pub. Date: Oct. 8, 2015

(54) COMPOSITION FOR LAMINATED CLIMBING SHOES

(71) Applicant: Nanotech Ceramics Co., Ltd., Busan City (KR)

(72) Inventor: Sang-Ok Jeong, Busan-si (KR)

(21) Appl. No.: 14/298,069

(22) Filed: Jun. 6, 2014

(30) Foreign Application Priority Data
Apr. 4, 2014 (KR) 10-2014-0040616

(51) Int. Cl. B32B 37/06; A43B 13/04; A43B 13/12; C08K 5/09; B32B 37/16; C08K 3/36; C08K 5/06; C08L 9/00; C08L 7/00; C08L 9/06; A43B 5/00; C08K 3/22

(52) U.S. Cl. CPC B32B 37/06; A43B 5/002; A43B 13/04; A43B 13/122; C08K 5/09; C08K 3/22; C08K 3/36; C08K 5/06; C08L 9/00; C08L 7/00; C08L 9/06; B32B 37/16; C08K 2003/2296; C08L 2205/03; B32B 2037/0092

(57) ABSTRACT

Embodiments of the present invention provide a method for constructing a shoe outsole. Specifically, among other things, embodiments of the present invention provide a laminated composite used to construct a climbing shoe outsole. The laminate composite includes distinctive lower and upper layers. The lower layer includes butyl rubber. The upper layer includes a general-purpose rubber and a visibility additive. The shoe outsole is formed from the laminated composite. The visibility additive is used to make each layer visually distinctive.

### CROSS-REFERENCE TO RELATED APPLICATION

This application claims priority under 35 U.S.C §119 to Korean Patent Application No. 10-2014-0040616, filed on Apr. 4, 2014, in the Korean Intellectual Property Office, the contents of which are incorporated herein by reference.

### BACKGROUND OF THE INVENTION

1. Field of the Invention

A shoe is an item of footwear intended to protect and comfort the human foot while doing various activities. Shoes are also used as an item of decoration. The design of shoes has varied enormously through time and from culture to culture, with appearance originally being tied to function. Additionally, fashion has often dictated many design elements, such as whether shoes have very high heels or flat ones. Contemporary footwear varies widely in style, complexity, and cost. Basic sandals may consist of only a thin sole and simple strap. High fashion shoes may be made of very expensive materials in complex construction and sell for thousands of dollars a pair. Other shoes are for very specific purposes, such as boots specially designed for climbing or skiing.

Known shoe soles generally have a three layered structure. They consist of an outsole, a midsole, and an inner sole. The outsole provides the shoe with an outer profile so that it meets the requirements of good grip with the respective ground. Furthermore, the outsole is typically made of a non-abrasive material to assure high wear resistance and a long lifetime of the sole. The midsole is often made of a foamed plastic (e.g., elastomers) with different densities. Based on the ability of the midsole material to deform reversibly, it absorbs or dampens mechanical impacts which are generated during the walking and running motions and which are transmitted to the body of the shoe wearer via the shoe. The damping of the mechanical impacts induced in this way can be supported by the integration of damping elements of different construction.

Additionally, the midsole often serves for receiving stability or support elements which are made of lightweight and stable plastics and which support the foot during walking and running. Based on their selectively adjustable flexibility, a further function of this stability or support element is the support of the walking and running motions of the shoe wearer.

2. Description of the Related Art

In general, a butyl rubber is widely used for tire inner liners, dustproof materials, automobile tubes, and the like, due to low gas permeation. Also, a butyl rubber is used as a material for climbing shoe outsoles owing to considerably superior non-slip properties.

Furthermore, as described above, the butyl rubber used as a material for climbing shoe outsoles secures safety against slip and improves grip strength between shoes and the ground during climbing, thereby enhancing wear sensation and comfort. In this regard, materials for climbing shoe outsoles using a butyl rubber with superior non-slip property attract much consumer attention.

However, companies that manufacture climbing shoes outsoles using a butyl rubber as a base material have a problem of high product defects due to low adhesive properties of butyl rubbers to midsoles or uppers.

In order to solve this problem, in an attempt to improve an adhesive strength through preliminary treatment, the adhesion surface of outsoles is subjected to buffing. However, such a buffing process causes various problems such as production of industrial wastes, noise, and product defects caused by buffing.

Also, an expensive chloroprene (CR) solvent-type adhesive agent is generally used as an adhesive agent of butyl rubbers. For this reason, problems such as increase in adhesion cost and bad workplace environments resulting from use of excess organic solvent occur. Accordingly, in an attempt to solve the non-adhesive property, a resin or general-purpose rubber is used in conjunction with a butyl rubber.

However, in general, a butyl rubber has a low compatibility with a resin or a general-purpose rubber, thus having considerably low non-slip property when used in combination therewith. In particular, when a butyl rubber is adhered to a general-purpose rubber by cross-linking, interfacial de-adhesion generally occurs due to the great difference in cross-linking speed between the rubbers and decreased compatibility.

In sulfur crosslinking, a butyl rubber has a considerably low cross-linking speed due to narrow cross-linkage sites. On the other hand, a general-purpose rubber has superior cross-linking activity in a sulfur cross-linking system, thus having a high cross-linking speed, as compared to a butyl rubber. For this reason, there is difficulty in cross-linking adhesion due to the great difference in cross-linking speed between the butyl rubber and the general-purpose rubber upon cross-linking adhesion.

There are conventional methods for adhering resins or rubbers for improving performance of compositions containing a butyl rubber as a base material. For example, a method for adhering a butyl rubber to a resin layer in the process of producing an inner liner for tires by adhering the butyl rubber to the resin layer and irradiating an electric beam thereto, to co-crosslink the butyl rubber and the resin layer is developed. However, in accordance with the method, selection of materials is limited in order to maintain adhesion strength, since adhesion strength between the butyl rubber and the resin layer depends on materials for the resin layer and butyl rubber members.

Meanwhile, as the related art, a method for adhering a resin layer to an adjacent rubber member using an indirect adhesive agent or a highly polar epoxy rubber is used. This indirect adhesive agent or highly polar rubber is expensive and entails use of compounding components having a high glass transition temperature, thus causing cracks or low-temperature resistance in winter and being unsuitable for shoes to which roughness is repeatedly applied.

Furthermore, Japanese Patent Publication No. 2007-276235 discloses cross-linkage performed by adhering a thermoplastic elastomer resin laminate to a rubber composition member, irradiating an electric beam to the resin-rubber laminate-provided member, and performing vulcanization. However, in accordance with this method, disadvantageously, a non-uniform net structure may be formed, heat resistance of rubber layer is decreased, and an interfacial de-adhesion thus occurs when an adhesive layer is not used, since carbon-carbon bonds and sulfur cross-linking are introduced into the rubber layer through electric beam irradiation and vulcanization.

Korean Patent Document No. 10-1311264 attempted to address such technical issues by disclosing a non-slip mountain climbing shoe outsole. Specifically, this method relates to a climbing shoe outsole with good adhesive and non-slip properties that has a structure including a butyl rubber as a lower layer of the outsole (side in contact with the ground), a general-purpose rubber as an upper layer of the outsole (side of the outsole adhered to a midsole or upper), and a method for same. However, if the lower layer (i.e., butyl rubber layer) and upper layer (i.e., general-purpose rubber layer) are the same color, it can be difficult to distinguish the layers. If butyl rubber gets carried forward to the upper layer, it will result in poor adhesion with a midsole or upper. If the general-purpose rubber gets carried forward to the lower layer, it will significantly reduce the outsole's non-slip characteristic. Additionally, if the lower and upper layers are composed in the same color, the rubber compound in each layer may not be altered during laminate molding which can ultimately result in product defection.

### RELATED ART

Patent Document 1: Japanese Patent Publication No. 2007-276235 entitled “Method for producing tires”.

Patent Document 2: Korean Patent Document No. 10-1311264 entitled “Highly adhesive and excellent non-slip mountain climbing shoes outsole as well as method for manufacturing thereof”.

### SUMMARY OF THE INVENTION

In general, embodiments of the present invention provide a method for constructing a shoe outsole. Specifically, among other things, embodiments of the present invention provide a laminated composite used to construct a climbing shoe outsole. The laminate composite includes distinctive lower and upper layers. The lower layer includes butyl rubber. The upper layer includes a general-purpose rubber and a visibility additive. The shoe outsole is formed from the laminated composite. The visibility additive is used to make each layer visually distinctive.

A first aspect of the present invention provides a shoe structure, comprising: a midsole; and an outsole adhered to the midsole, wherein the outsole is formed from an laminated composite having a distinctive upper layer and a distinctive lower layer, wherein the lower layer includes butyl rubber and the upper layer includes a general-purpose rubber and a visibility additive.

A second aspect of the present invention provides a method for constructing a laminated climbing shoe outsole composition, comprising: providing a lower layer, wherein the lower layer includes butyl rubber; providing an upper layer, wherein the upper layer includes general-purpose rubber having a sheet form, wherein the general-purpose rubber having a sheet form includes 2 to 5 parts by weight of metallic oxide, 0.5 to 1.5 parts by weight of stearine, 30 to 60 parts by weight of silica, 0.5 to 4 parts by weight of a silane coupling agent, 0.5 to 1.5 parts by weight of polyethylene glycol, 5 to 20 parts by weight of a visibility additive, 0.5 to 1.5 parts by weight of a vulcanizing agent, and 0.5 to 2 parts by weight of a vulcanizing catalyst, with respect to 100 parts by weight of general-purpose rubber; and performing a cross-linking adhesion process to adhere the lower layer to the upper layer.

A third aspect of the present invention provides a method for constructing a shoe outsole, comprising: providing an laminated composite, wherein the laminated composite includes a distinctive upper layer and a distinctive lower layer, wherein the lower layer includes butyl rubber and the upper layer includes a general-purpose rubber and a visibility additive; and forming a shoe outsole from the outsole composite and an outsole adhered to the midsole, wherein the outsole is formed from an laminated composite having a distinctive upper layer and a distinctive lower layer, wherein the lower layer includes butyl rubber and the upper layer includes a general-purpose rubber and a visibility additive.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an actual view of a laminated outsole composition with visually distinctive layers according to an embodiment of the present invention.

FIG. 2 depicts a flow diagram of a manufacturing method for laminated outsole composition with distinctive layers according to an embodiment of the present invention.

FIG. 3 depicts a table illustrating a summary of the source ingredient proportions according to an embodiment of the present invention.

FIG. 4 depicts a comparison view of Illustration 1 and Comparison 1 of an actual view of an outsole according to an embodiment of the present invention.

FIG. 5 depicts a table illustrating outsole characteristics based on assessment parameters according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

To address the aforementioned issues, a climbing shoe outsole is produced by laminating a general-purpose rubber as an upper layer of the outsole (side of the outsole adhered to a midsole or upper) on butyl rubber as a lower layer of the outsole (side in contact with the ground). The composition for the laminated climbing shoe outsole will have visually distinctive layers.

As discussed above, embodiments of the present invention provide a method for constructing a shoe outsole. Specifically, among other things, embodiments of the present invention provide a laminated composite used to construct a climbing shoe outsole. The laminate composite includes distinctive lower and upper layers. The lower layer includes butyl rubber. The upper layer includes a general-purpose rubber and a visibility additive. The shoe outsole is formed from the laminated composite. The visibility additive is used to make each layer visually distinctive.

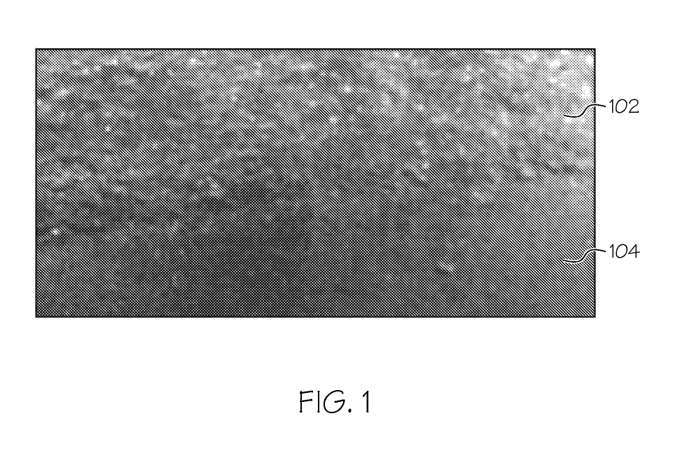

FIG. 1 depicts an actual view of a laminated outsole composition with visually distinctive layers (upper general-purpose rubber layer 102 and lower butyl rubber layer 104) according to an embodiment of the present invention. The laminate molding will allow easy distinction between the rubber compounds used in the lower and upper layers. Therefore, in cases of issues such as outsole adhesion and reduction in non-slip strength due to rubber compounds being carried forward from one layer to another, the issues can be detected and alleviated beforehand in order to prevent defects in manufactured outsoles.

The butyl rubber layer may include one of any number of butyl rubber-based compositions. In one example, the butyl rubber layer may include: 2 to 5 parts by weight of metallic oxide; 0.5 to 1.5 parts by weight of stearine; 30 to 60 parts by weight of silica; 0.5 to 4 parts by weight of a silane coupling agent; 0.5 to 4 parts by weight of polyethylene glycol; 1.5 to 2.5 parts by weight of a vulcanizing agent; and 1 to 4 parts by weight of a vulcanizing catalyst, with respect to 100 parts by weight of butyl rubber. Additionally, the butyl rubber may be butyl rubber (IIR), bromobutyl rubber (BIIR), and/or chlorinated butyl rubber (CIIR). The butyl rubber as described herein may include any of these rubber types, used either independently or compositely.

The general-purpose rubber layer may include: 2 to 5 parts by weight of metallic oxide; 0.5 to 1.5 parts by weight of stearine; 30 to 60 parts by weight of silica; 0.5 to 4 parts by weight of a silane coupling agent; 0.5 to 1.5 parts by weight of polyethylene glycol; 5 to 20 parts by weight of a visibility additive; 0.5 to 1.5 parts by weight of a vulcanizing agent; and 0.5 to 2 parts by weight of a vulcanizing catalyst, with respect to 100 parts by weight of butyl rubber. Additionally, the butyl rubber may be butyl rubber (IIR), bromobutyl rubber (BIIR), and/or chlorinated butyl rubber (CIIR). The butyl rubber as described herein may include any of these rubber types, used either independently or compositely. Additionally, the general-purpose rubber used herein is understood to include any standard, conventional rubber that is widely used in the composition of shoe outsoles. The general-purpose rubber may include one of any number of compositions. For illustrative purposes, the general-purpose rubber may include 25 to 40% by weight of natural rubber, 20 to 50% by weight of butadiene rubber, and/or 25 to 40% by weight of styrene-butadiene rubber.

Natural rubber is highly compatible with silica and can further reinforce silica. If natural rubber usage is less than 25% by weight, it decreases the compatibility with silica and does not reinforce silica. If the usage is more than 40% by weight, the formability can substantially decrease. Butadiene rubber increases abrasion durability and mechanical strength. If butadiene rubber usage is less than 20% by weight, it may increase open roll mill behavior, but properties such as the mechanical strength and abrasion durability can diminish. If butadiene rubber usage is over 50%by weight, the flow becomes low, which diminishes open roll mill behavior. The styrene-butadiene rubber maintains the rubber compound's gradient and mechanical strength and adjusts the rubber compound's adhesion. If the styrene-butadiene rubber usage is below 25%, properties such as the general-purpose rubber compound's gradient and mechanical strength can diminish. If the usage is over 40%, the rubber compound's gradient may be too great, which may diminish formability.

The metallic oxide, stearine, silica, silane coupling agent, polyethylene glycol, vulcanizing agent, and vulcanizing catalyst are conventionally used additives in outsoles. Therefore, detailed explanations have been omitted. The usage amounts specified herein are for illustrative purposes only and not intended to be limiting. The usage amounts may be based on the type of outsole, purpose of outsole, environment, and the like.

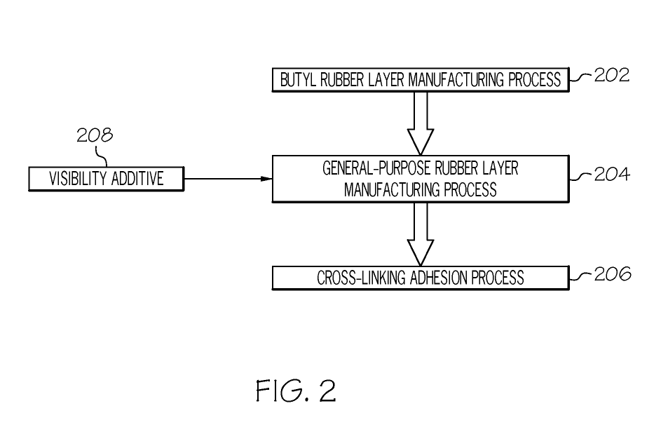

FIG. 2 depicts a flow diagram of a manufacturing method for laminated outsole composition with distinctive layers according to an embodiment of the present invention. As shown, the flow includes butyl rubber layer manufacturing process 202, general-purpose rubber layer manufacturing process 204, and cross-linking adhesion process 206.

For the butyl rubber layer manufacturing process 202, the butyl rubber layer may include: 2 to 5 parts by weight of metallic oxide; 0.5 to 1.5 parts by weight of stearine; 30 to 60 parts by weight of silica; 0.5 to 4 parts by weight of a silane coupling agent; and 0.5 to 4 parts by weight of polyethylene glycol 0.5-4, with respect to 100 parts by weight of butyl rubber. Each ingredient is mixed together in a kneader for 10 to 15 minutes. Finally, a sheet-form butyl rubber layer is created by adding 1.5 to 2.5 parts by weight of a vulcanizing agent and 1 to 4 parts by weight of a vulcanizing catalyst, with respect to 100 parts by weight of butyl rubber, in a roll mill.

With regard to the general-purpose rubber layer manufacturing process 204, the general-purpose rubber layer may include 25 to 40% by weight of natural rubber, 20 to 50% by weight of butadiene rubber, and 25 to 40% by weight of styrene-butadiene rubber. Additionally, the general-purpose rubber layer may include: 2 to 5 parts by weight of metallic oxide; 0.5 to 1.5 parts by weight of stearine; 30 to 60 parts by weight of silica; 0.5 to 4 parts by weight of a silane coupling agent; 0.5 to 1.5 parts by weight of polyethylene glycol, with respect to 100 parts by weight of general-purpose rubber. All ingredients are mixed together in a kneader for 10 to 13 minutes at a temperature of 110° and 130° Celsius (C). Subsequently, 5 to 20 parts by weight of a visibility additive with respect to 100 parts by weight of the general-purpose rubber is mixed into the composition using a kneader for 1 to 2 minutes. Finally, a sheet-form general-purpose rubber layer is created by adding 0.5 to 1.5 parts by weight of a vulcanizing agent and 0.5 to 2 parts by weight of a vulcanizing catalyst, with respect to 100 parts by weight of the general-purpose rubber, in a roll mill.

As shown in FIG. 2, a visibility additive 208 may be applied in the upper, general-purpose rubber layer to facilitate easy distinction between the upper and lower layers. The general-purpose rubber layer may include 5 to 20 parts by weight of the visibility additive 208 with respect to 100 parts by weight of a general-purpose rubber. If the weight percentage of the visibility additive 208 is below 5%, then the distinction effectiveness with the butyl rubber layer decreases. If over 20%, the general-purpose rubber's viscosity increases, and the interface may fall during cross-linking due to the difference in viscosity with the butyl rubber.

In one example, the visibility additive 208 may include mica that is surface and heat treated with a silane coupling agent. In another example, the visibility additive 208 may include alumina that is surface and heat treated with titanium dioxide.

Regarding the mica that is surface and heat treated with a silane coupling agent, the mica may include: 0.5-2 parts by weight of the silane coupling agents with respect to 100 parts by weight of mica. The surface treatment process is performed. The heating treatment process is then performed for 1 to 3 hours at temperatures between 110° and 130° Celsius (C). Additionally, the average critical diameter of the mica may be between 150 micrometers (um) and 2 millimeters (mm). If the average critical diameter is less than 150 um, the distinction effectiveness with the butyl rubber layer diminishes. If the diameter is more than 2 mm, the mechanical strength of the general-purpose rubber substantially weakens due to low compatibility with the rubber and this influences the cross-linking rate which becomes problematic in the adhesion of the butyl rubber layer and general-purpose rubber layer.

In addition, if the weight of the silane coupling agent is less than 0.5 parts by weight, the compatibility with the rubber decreases which leads to low mechanical strength. If the weight exceeds 2 parts by weight, this influences the general-purpose rubber's cross-linking rate which decreases the adhesiveness during laminated molding and causes the butyl rubber layer and general-purpose rubber layer's interfacial de-adhesion.

Also, if the mica is not heat processed, the mica's average critical diameter shrinks below 150 um due to mechanical shear force during the kneader's dispersion, which causes the distinctiveness with the butyl rubber layer to fail?. Therefore, as mentioned above, the mica is heat processed at between 110° and 130° C. for 1 to 3 hours. If this is not done, compatibility with the rubber may be at issue.

In one example, the silane coupling agent used for mica surface processing may be a vinyl silane such as vinyltrietoxysilane, vinyl tris (2-methoxyethoxy) silane, 3-methacryloyloxypropyltrimethoxysilane, N-phenyl-3-aminopropyltrimethoxysilane, 3-mercaptopropyltrimethoxysilane, bis (triethoxysilypropyl) tetrasulfane, or 3-thiocyanatopropyltriethoxysilane. Among these, bis (triethoxysilypropyl) tetrasulfane, or 3-thiocyanatopropyltriethoxysilane may be used for increased vulcanized cross-linking.

Regarding the alumina that is surface and heat treated with a titanium dioxide agent, the alumina may include: 0.5-2 parts by weight of the titanium dioxide with respect to 100 parts by weight of alumina. The surface treatment process is performed. The heating treatment process is then performed for 1 to 3 hours at a temperature between 110° and 130° C. Additionally, the average critical diameter of the alumina may be between 150 um and 2 mm.

At this point, if the average critical diameter falls below 150 um, the distinctiveness with the butyl rubber is decreased. If the average critical diameter exceeds 2 mm, the mechanical strength of the general-purpose rubber weakens due to low compatibility with the rubber. Furthermore, it affects the cross-linking rate where the adhesion between the butyl and general-purpose rubber layers becomes problematic.

In addition, with regard to the alumina's surface processing, if titanium dioxide is below 0.5 parts by weight, the mechanical strength weakens due to low compatibility with the rubber. If the parts by weight exceeds 2, this may influence the general-purpose rubber's cross linking rate which causes the adhesiveness to fall during laminated molding and, ultimately, interfacial de-adhesion between the butyl rubber and general-purpose rubber layers may occur.

If the alumina is not heat processed, the mica's average critical diameter shrinks below 150 um due to mechanical shear force during the kneader's dispersion, which causes the distinctiveness with the butyl rubber layer to fall. Therefore, as mentioned above, the alumina needs to be heat processed between 110° and 130° C. for 1 to 3 hours. If not done, the compatibility with rubber may be at issue.

The cross-linking adhesion process 206 includes laminating the manufactured butyl rubber layer and general-purpose rubber layers and molding them in a press for 12 to 17 minutes at temperatures reaching 150 to 170° C. and pressure of 110 to 120 kg/cm2. At this point, if the temperature and/or pressure required for the cross-linking adhesion process 206 falls outside of the ranges above, the butyl rubber layer and/or the general-purpose rubber layer's properties may decline or incur defects.

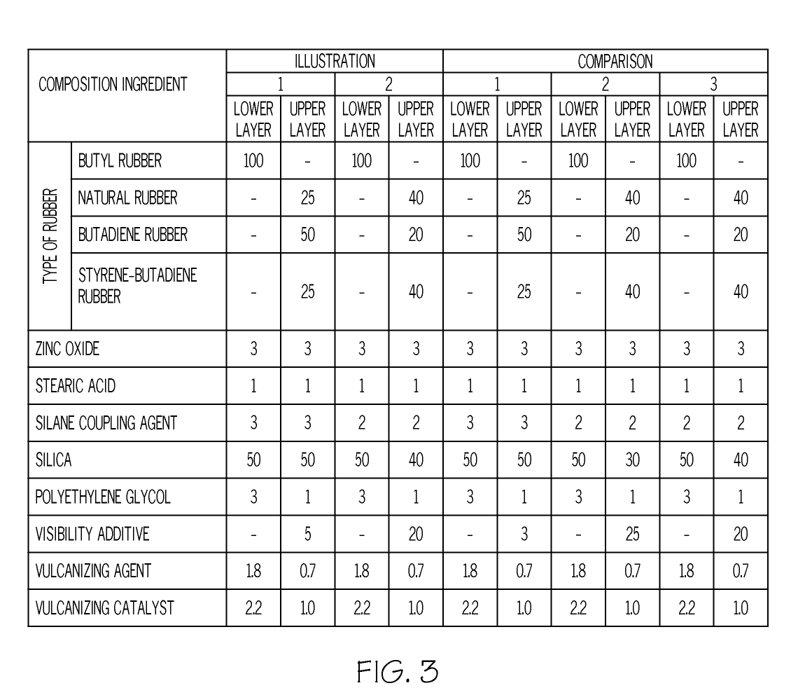

FIG. 3 depicts a table illustrating a summary of the source ingredient proportions of Illustrations 1 and 2, along with Comparisons 1, 2, and 3. In Illustration 1, mica is the visibility additive. As shown, the mica includes 0.5 parts by weight of a silane coupling agent with respect to 100 parts by weight of mica. The surface treatment process is performed, followed by the heating treatment process performed for 1 hour at a temperature of 110° C. A visibility additive with an average critical additive of 150 um is created.

With respect to Illustration 1, a climbing shoe outsole is manufactured with the source ingredients below. Per 100 parts by weight of butyl rubber, 3 parts by weight of zinc oxide 3, 1 part by weight of stearine, 3 parts by weight of polyethylene glycol, 3 parts by weight of a silane coupling agent, and 50 parts by weight of silica 50 are mulled for approximately 12 minutes at 100° C. in a kneader (i.e., a compound mixer). Subsequently, 1.8 parts by weight of a vulcanizing agent and 2.2 parts by weight of a vulcanizing catalyst and evenly mixed to manufacture a 3 to 4 mm butyl rubber layer in sheet form in an open roll mill.

The general-purpose rubber includes 25% by weight of natural rubber, 50% by weight of styrene-butadiene rubber, and 25% by weight of butadiene rubber. The general-purpose rubber layer includes: 3 parts by weight of zinc oxide; 1 part by weight of stearine; 1 part by weight of polyethylene glycol; 1 part by weight of a silane coupling agent; and 50 parts by weight of silica, with respect to 100 parts by weight of general-purpose rubber. The source ingredients are mixed in a kneader at 100° C. for approximately 10 minutes. Then, 5 parts by weight of the visibility additive of Illustration 1 is added and mixed in for 2 minutes to manufacture the final compound. To this compound, 0.7 parts by weight of a vulcanizing agent and 1 part by weight of a vulcanizing catalyst are added and evenly mixed to manufacture a 1 to 2 mm sheet form general-purpose rubber layer in an open roll mill. A laminate molding process is performed on the butyl rubber layer and general-purpose rubber layer and then laminated on a mold. At 160° C. in a 120 kg/cm2 press setting, the laminate is press molded for 15 minutes to create the outsole.

In Illustration 2, alumina is the visibility additive. Per 100 parts of alumina, 2 parts of titanium dioxide is used in the surface treatment process. The visibility additive is then heat processed at 130° C. for 3 hours. The visibility additive having an average critical diameter of 2 mm is created.

With respect to Illustration 2, a climbing shoe is manufactured. Per 100 parts by weight of butyl rubber, 3 parts by weight of zinc oxide, 1 part by weight of stearine, 3 parts by weight of polyethylene glycol, 3 parts by weight of a silane coupling agent, and 40 parts by weight of silica are mixed in a kneader at 100° C. for approximately 12 minutes to manufacture a compound. To the compound, 1.8 parts by weight of a vulcanizing agent and 2.2 parts by weight of a vulcanizing catalyst are evenly mixed into the compound in an open roll mill to manufacture a 3 to 4 mm sheet form butyl rubber layer.

As shown, the general-purpose rubber includes 40% natural rubber, 20% styrene-butadiene rubber and 40% butadiene rubber. The general-purpose rubber layer includes: 3 parts by weight of zinc oxide; 1 part by weight of stearine; 1 part by weight of polyethylene; 1 part by weight of a silane coupling agent; and 30 parts by weight of silica 30, with respect to 100 parts by weight of the general-purpose rubber. The source ingredients are mixed in a kneader at 100° for approximately 10 minutes and then 10 parts by weight of the visibility additive (as shown in Illustration 2) is added and mixed for 2 minutes to manufacture the compound. Then 0.7 parts by weight of a vulcanizing agent and 1 part by weight of a vulcanizing catalyst are added to the compound and evenly mixed to manufacture a 1 to 2 mm general-purpose rubber layer in sheet form. The butyl rubber layer and general-purpose rubber layer are laminated on a mold. At 160° C. in a 120 kg/cm2 press setting, the laminate is press molded for 15 minutes to create the outsole.

With respect to Comparison 1, the method similar to Illustration 1 is used. The only difference is 3 parts by weight of the visibility additive is used. With respect to Comparison 2, a method similar to Illustration 2 is used. The differences include 30 parts by weight of silica with respect to 100 parts by weight of rubber is used. Also, 25 parts by weight of the visibility additive is used.

Referring now to Comparison 3, 100 parts by weight of butyl rubber, 3 parts by weight of zinc oxide, 1 part by weight of stearine, 3 parts by weight of polyethylene glycol, 3 parts by weight of a silane coupling agent, and 50 parts by weight of silica are mixed in a kneader at 100° C. for approximately 12 minutes to manufacture the compound. After adding 1.8 parts by weight of a vulcanizing agent and 2.2 parts by weight of a vulcanizing catalyst, the resulting compound is evenly mixed, and a 3 to 4 mm sheet form butyl rubber layer is created. Next, the general-purpose rubber consists of 40% natural rubber, 20% styrene-butadiene rubber, and 40% butadiene rubber. Then 3 parts by weight of zinc oxide, 1 part by weight of stearine, 1 part by weight of polyethylene glycol, 1 part by weight of a coupling agent, 40 parts by weight of silica, and 20 parts by weight of the visibility additive are mixed in a kneader at 100° C. for approximately 13 minutes to manufacture a compound. Then 0.7 parts by weight of a vulcanizing agent and 1 part by weight of a vulcanizing catalyst are added to the compound and evenly mixed to manufacture a 1 to 2 mm sheet form general-purpose rubber layer. After this process, the butyl rubber layer and general-purpose rubber layer are laminated on a mold. At 160° C. in a 120 kg/cm2 press setting, the laminate is press molded for 15 minutes to create the outsole.

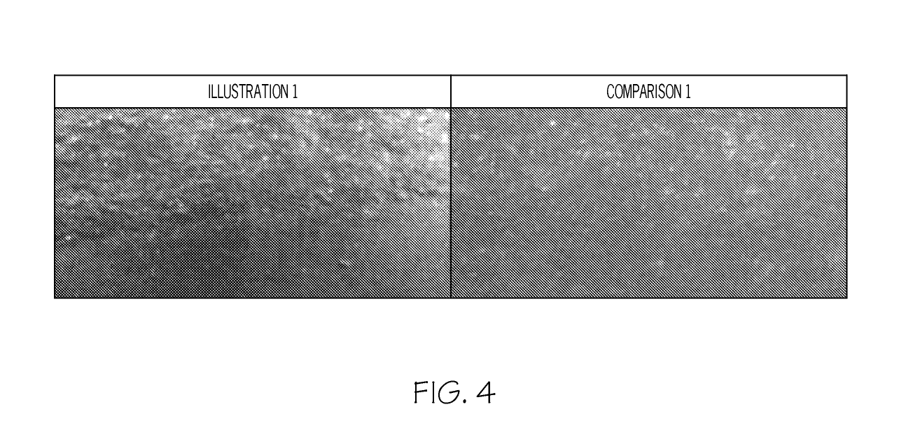

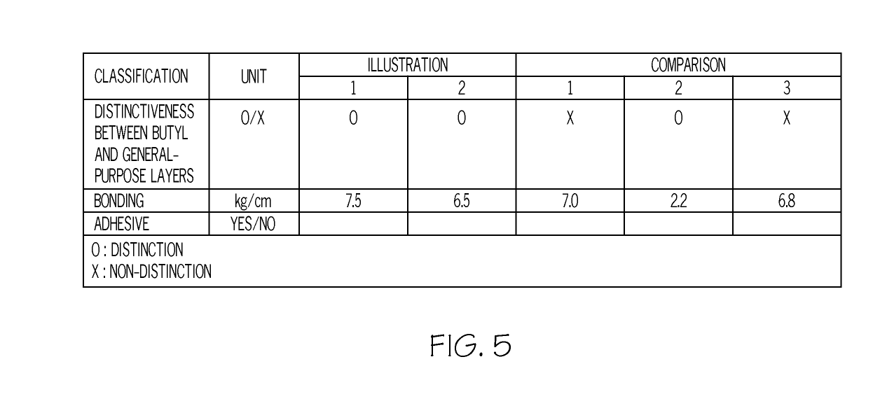

FIG. 4 depicts a comparison view of Illustration 1 and Comparison 1 of an actual view of an outsole. Based on below assessment parameters, characteristics of an outsole based on Illustrations 1 and 2 and Comparisons 1, 2, and 3 are stated in table 2 as well as in FIG. 3. FIG. 3 depicts a comparison view of Illustration 1 and Comparison 1 of an actual view of an outsole according to an embodiment of the present invention. FIG. 5 depicts a table illustrating resulting outsole characteristics relating to the Illustrations and Comparisons shown in FIG. 3. The assessment parameters include bonding strength and adhesive strength.

As shown in FIGS. 3 and 5, the outsole following Illustrations 1 and 2 produced favorable distinctiveness of each layer and bonding strength after the lamination of the butyl rubber layer and general-purpose rubber layer. Comparison 1 lacked distinctiveness due to the low usage of the visibility additive. Comparison 2 lacked interfacial adhesion due to high visibility additive usage. Lastly, in the case of Comparison 3, the manufacturing of the general-purpose rubber layer bypassed the second step of the process and simultaneously added and mixed the visibility additive, which caused non-distinctiveness of the butyl rubber and general-purpose rubber due to critical diameter reduction of the visibility additive.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A shoe structure, comprising:
a midsole; and
an outsole adhered to the midsole, wherein the outsole is formed from an laminated composite having a distinctive upper layer and a distinctive lower layer, wherein the lower layer includes butyl rubber and the upper layer includes a general-purpose rubber and a visibility additive.

2. The shoe structure of claim 1, wherein the upper layer includes 2 to 5 parts by weight of metallic oxide, 0.5 to 1.5 parts by weight of stearine, 30 to 60 parts by weight of silica, 0.5 to 4 parts by weight of a silane coupling agent, 0.5 to 1.5 parts by weight of polyethylene glycol, 5 to 20 parts by weight of the visibility additive, 0.5 to 1.5 parts by weight of a vulcanizing agent, and 0.5 to 2 parts by weight of a vulcanizing catalyst, with respect to 100 parts by weight of the general-purpose rubber.

3. The shoe structure of claim 1, wherein the visibility additive includes mica.

4. The shoe structure of claim 3, wherein the mica is surface processed using a silane coupling agent.

5. The shoe structure of claim 4, wherein the mica is heat processed.

6. The shoe structure of claim 5, wherein the mica is surface processed using 0.5 to 2 parts by weight of the silane coupling agent with respect to 100 parts by weight of mica and the mica is heat processed for 1 to 3 hours at 110 to 130 degrees Celsius.

7. The shoe structure of claim 5, wherein the average critical diameter of the mica is between 150 micrometers and 2 millimeters.

8. The shoe structure of claim 1, wherein the visibility additive includes alumina.

9. The shoe structure of claim 8, wherein the alumina is surface processed using titanium dioxide.

10. The shoe structure of claim 7, wherein the alumina is heat processed.

11. A method for constructing a laminated climbing shoe outsole composition, comprising:
providing a lower layer, wherein the lower layer includes butyl rubber;
providing an upper layer, wherein the upper layer includes general-purpose rubber having a sheet form, wherein the general-purpose rubber having a sheet form includes 2 to 5 parts by weight of metallic oxide, 0.5 to 1.5 parts by weight of stearine, 30 to 60 parts by weight of silica, 0.5 to 4 parts by weight of a silane coupling agent, 0.5 to 1.5 parts by weight of polyethylene glycol, 5 to 20 parts by weight of a visibility additive, 0.5 to 1.5 parts by weight of a vulcanizing agent, and 0.5 to 2 parts by weight of a vulcanizing catalyst, with respect to 100 parts by weight of general-purpose rubber; and
performing a cross-linking adhesion process to adhere the lower layer to the upper layer.

12. The method of claim 11, wherein the metallic oxide, stearine, silica, silane coupling agent, and the polyethylene glycol are mixed together in a kneader at 90 to 110 degrees Celsius for 10 to 13 minutes to create a compound.

13. The method of claim 12, wherein the visibility additive is mixed with the compound for 1 to 2 minutes in a roll mill.

14. The method of claim 11, wherein the visibility additive includes mica.

15. The method of claim 11, wherein the visibility additive includes alumina.

16. A method for constructing a shoe outsole, comprising:
providing an laminated composite, wherein the laminated composite includes a distinctive upper layer and a distinctive lower layer, wherein the lower layer includes butyl rubber and the upper layer includes a general-purpose rubber and a visibility additive; and
forming a shoe outsole from the outsole composite and an outsole adhered to the midsole, wherein the outsole is formed from an laminated composite having a distinctive upper layer and a distinctive lower layer, wherein the lower layer includes butyl rubber and the upper layer includes a general-purpose rubber and a visibility additive.

17. The method of claim 16, wherein the upper layer includes 2 to 5 parts by weight of metallic oxide, 0.5 to 1.5 parts by weight of stearine, 30 to 60 parts by weight of silica, 0.5 to 4 parts by weight of a silane coupling agent, 0.5 to 1.5 parts by weight of polyethylene glycol, 5 to 20 parts by weight of the visibility additive, 0.5 to 1.5 parts by weight of a vulcanizing agent, and 0.5 to 2 parts by weight of a vulcanizing catalyst, with respect to 100 parts by weight of the general-purpose rubber.

18. The method of claim 16, wherein the visibility additive includes mica.

19. The method of claim 16, wherein the visibility additive includes alumina.

20. The method of claim 16, wherein the general-rubber includes at least one of natural rubber, butadiene rubber, or styrene-butadiene rubber.
